(19) United States
(12) Patent Application Publication
(10) Pub. No.: US 2012/0210615 A1
(43) Pub. Date: Aug. 23, 2012

(54) Reminder Device And Method Of Use

(76) Inventor: Mollie Coney, Fayetteville, NC (US)

(21) Appl. No.: 13/030,330

(22) Filed: Feb. 18, 2011

(51) Int. Cl. G09F 3/00; C09J 7/02; G09F 3/10

(52) U.S. Cl. 40/324; 40/299.01; 428/42.3

(57) ABSTRACT

a reminder device comprising an object, where the object is readily viewed by a user; and a marking on the object wherein the marking includes a circle and a pair of words “TO IT”. The circle with the pair of words “TO IT” is associated with the phrase “GET 'ROUND TO IT” to remind the user of the action they need to complete. The markings may be placed on a magnet, a token, a sticker, a paperweight, a coin, a lamp, a mug, a glass or other commonly used household items to remind and inspire action to a user upon viewing it.

### BACKGROUND OF THE INVENTION

1. Field of the Invention

The present invention relates to a device used to remind a person of an action to be completed where upon viewing the device the person will remember the action to be completed and be motivated to complete it.

2. Description of Related Art

Procrastination is a counterproductive habit that can hinder people from achieving goals, completing tasks, or fulfilling other important obligations. Many people have trained themselves to always wait until the last minute to complete projects or perform duties. They usually don't try to get a head start on the work and simply put off performance until the last minute to finish. Alternatively, some people are forgetful and need continuous reminders to stay on task. These individuals may have good intentions to complete the task early but either they get distracted or simply forget and by the time they remember again they have little or no time to complete their work.

Currently, there are some devices that may be used to remind or motivate a person of an action to be performed. For example, U.S. Pat. No. 876,948 by F. K. Dexter discloses a memorandum tablet wherein a writing surface is combined on an outer portion of a pocket watch. A user may write their engagements and duties on the writing surface to ensure that they will not forget what needs to be done. Additionally, U.S. Pat. No. 4,179,833 by Robert R. Knodel discloses an information reminding device wherein the device includes a strap-like body worn around a person's wrist. The strap-like body allows one or more reminder tabs to be strung from it. The reminder tabs include tasks, duties or events that the person wants to remember and they wear the strap-like body like a bracelet to remember what they have to do. While the prior art does include examples of reminding devices they do not inspire motivation to complete the task at hand. As such it would be desirable in the art to provide a device that not only reminds a user of an action to be completed but also inspires performance for a user to complete the action.

### SUMMARY OF THE INVENTION

In view of the foregoing disadvantages inherent in the prior art, the purpose of the present disclosure is to provide a device used to remind a person of an action to be completed where upon viewing the device the person will remember the action to be completed and be motivated to complete it.

To achieve the above objects, in an aspect of the present invention, a reminder device comprising an object, where the object is readily viewed by a user; and a marking on the object wherein the marking includes a circle and a pair of words “TO IT”. The circle with the pair of words “TO IT” is associated with the phrase “GET 'ROUND TO IT” to remind the user of the action they need to complete. The markings may be placed on a magnet, a token, a sticker, a paperweight, a coin, a lamp, a mug, a glass or other commonly used household items to remind and inspire action to a user upon viewing it.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a topside view of a reminder device in accordance with an exemplary embodiment of the present invention;

FIG. 2 depicts a side view of a reminder device in accordance with an exemplary embodiment of the present invention;

FIG. 3 depicts a topside view of a reminder device in accordance with a second embodiment of the present invention;

FIG. 4 depicts a side view of a reminder device in accordance with a second embodiment of the present invention;

FIG. 5 depicts a perspective view of a sheet of reminder stickers in accordance with a third embodiment of the present invention; and

FIG. 6 depicts a perspective view of a reminder lamp in accordance with a fourth embodiment of the present invention.

Like reference numerals refer to like parts throughout the description of several views of the drawings.

### DETAILED DESCRIPTION OF THE DRAWINGS

The present invention relates to a device used to remind a person of an action to be completed where upon viewing the device the person will remember the action to be completed and be motivated to complete it. The device is an ornamental object that includes a marking comprising a circle with the words “TO IT” printed, drawn, etched or sewn on a top surface. The circle with the centrally printed “TO IT” represents the widely recognized saying “GET ROUND TO IT”. When the user reads the words “TO IT” inside of the circle the user is reminded of the action they need to complete and they are motivated to “GET 'ROUND TO IT” and complete the action. The device may be a lamp, token, coin, magnet, mug, glass, paperweight, and a myriad of household items and consumer goods. By providing the marking on common consumer goods, the device is especially useful for those individuals who may need additional reminders and persuasion to complete their actions.

Tuning now descriptively to the drawings, referring to FIG. 1, a topside view of a reminder device (10) is shown in accordance with an exemplary embodiment of the present invention. The reminder device (10) includes a top surface (12) to completely cover an upper portion of the reminder device (10). The top surface (12) may comprise a generally round or circular shape. On a central portion of the top surface (12) is a central marking (14). The central marking (14) includes a circle and within a center of the circle is a pair of words or a saying comprising “TO IT” wherein the “TO” is positioned above the “IT”. The fonts used for the pair of words “TO IT” may be any font of the user's choosing depending on their personal likes and preferences.

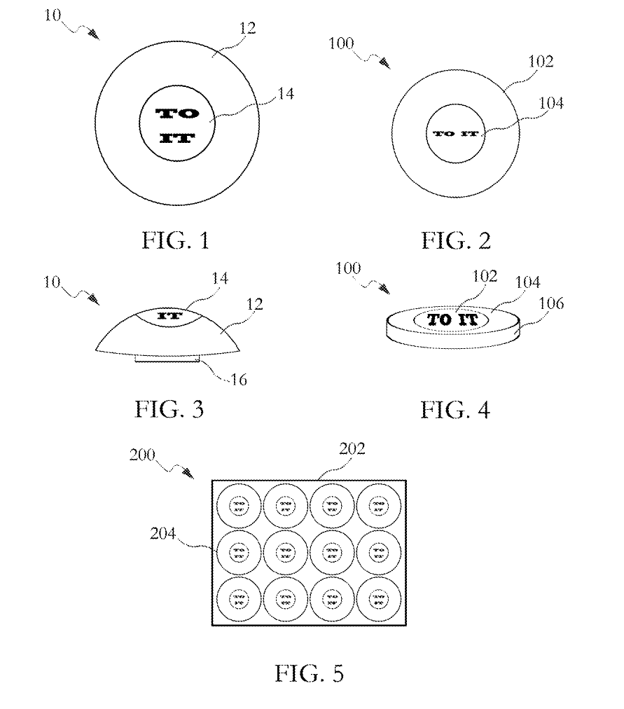

Referring now to FIG. 2, a side view of the reminder device (10) is shown in accordance with an exemplary embodiment of the present invention. Fastened to an underside of the top surface (12) is a magnet (16). The magnet (16) enables the reminder device (10) to be applied upon a fridge, bulletin board or another metallic surface commonly used to attach a magnet. The reminder device (10) is attached to a surface where the user will notice it, and then will be reminded of the action they were supposed to complete.

Accordingly, referring to FIG. 3, a topside view of a reminder device (100) is shown in accordance with a second embodiment of the present invention. The reminder device (100) includes a top surface (102) and a central marking (104). The central marking (104) comprises a circle around a pair of words saying “TO IT” wherein the “TO” is positioned on the left side of “IT”. Likewise, “TO” may be positioned above “IT”, as in FIG. 1. The positions of “TO” and “IT” are interchangeable between what is illustrated in FIG. 1 and FIG. 2 for use with the reminder device.

Referring to FIG. 4, a side view of the reminder device (100) is shown in accordance with a second embodiment of the present invention. The reminder device (100) may be a token, a paperweight, a coin or a generally small object that may be placed on a desktop, in a pocket or in a bag or purse. Accordingly, the reminder device (100) includes an elevated side (106) to raise the top surface (102). During use, when the user comes across the reminder device (100) either by viewing it on their desk, brushing against it in their pocket or touching it in their bag they are reminded of the actions needed to be performed and the association with “GET 'ROUND TO IT” motivates the user to perform the action.

Referring to FIG. 5, a perspective view of a sheet of reminder stickers (200) is shown in accordance with a third embodiment of the present invention. The sheet of reminder stickers (200) comprises a backing (202), upon which to apply a plurality of reminder stickers (204). Each of the plurality of reminder stickers (204) include the words “TO IT” to remind the user to “GET 'ROUND TO IT” upon view. A reminder sticker (204) may be applied to any object or surface so desired by the user. For example the user may place one of the reminder stickers to a computer screen, a cell phone, a window, a wallet, an article of clothing, a watch, a calendar or any other location where the user may glance and be reminded of an associated action that needs to be performed.

For use, the user thinks of an action, task, duty, aspiration, objective or the like to be completed that they must remember. Next, the user places the reminder device on a fridge, a bulletin board, computer screen, watch, or wallet or alternatively places it in their pocket or bag. Then they consciously associate the action to be completed with the reminder device. Finally, when the user comes across where they placed the reminder device and they view the device they will be reminded of the action that needs completion. The user is reminded to “GET 'ROUND TO IT” meaning that they should get back to the action at hand and complete their necessary duties. The “GET 'ROUND TO IT” phrase motivates the user to perform the previously thought of action, task, duty, aspiration or objective so that its completion is not delayed.

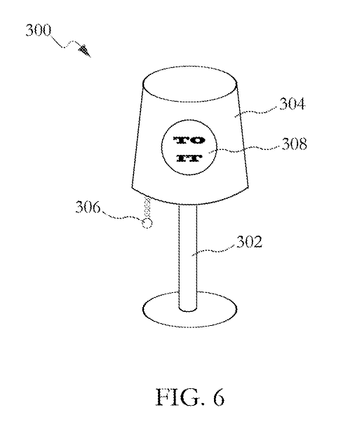

Referring to FIG. 6, a perspective view of a reminder lamp (300) is shown in accordance with a fourth embodiment of the present invention. The reminder lamp (300) comprises a lamp (302) combined with a lampshade (304). The lamp (302) is illuminated after a user activates a light bulb within the lampshade (304). The lamp (302) may be activated by pulling a string (306) or by flipping a switch. On an outer surface of the lampshade (304) is a marking (308) wherein the marking (308) includes a circle and a pair of words “TO IT”. When the reminder lamp (300) is activated the circle illuminates to showcase the pair of words “TO IT”. The illuminated “TO IT” reminds the user to “GET 'ROUND TO IT” or get back to an action that needs to be completed. The reminder lamp (300) may serve as an aesthetically pleasing reminder of pending obligations, events, duties, tasks or aspirations. As such, the reminder lamp (300) may be placed in an obvious location where the user is sure to see it, to ensure that the user remembers and performs the necessary actions.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A reminder device comprising:
an object , where said object is readily viewed by a user; and
a marking on said object wherein said central marking includes a circle and a pair of words “TO IT”.

2. The reminder device according to claim 1, wherein said circle and said pair of words “TO IT” is associated with a phrase meaning “GET 'ROUND TO IT”.

3. The reminder device according to claim 1, wherein said object is one of at least a magnet, a token, a paperweight, a coin, a lamp, a mug and a glass.

4. The reminder device according to claim 3, wherein said magnet enables a user to place said reminder device on a metallic surface.

5. The reminder device according to claim 1, wherein said reminder device is a sheet of stickers with a plurality of reminder stickers to place on an object.

6. The reminder device according to claim 1, wherein said pair of words “TO IT” are positioned where “TO” is above “IT”.

7. The reminder device according to claim 1, wherein said pair of words “TO IT” are positioned “TO” on a left side of “IT”.

8. A method of use for a reminder device comprising the steps of:
thinking of an action to be completed;
associating said reminder device with said action to be completed;
viewing said reminder device; and
remembering said action to be completed;

9. The method of use for the reminder device according to claim 8 further comprising the step of performing said action to be completed.

10. The method of use for the reminder device according to claim 9 further comprising the step of placing said reminder device in a place viewed by a user.
